(19) United States
(12) Patent Application Publication
(10) Pub. No.: US 2005/0154885 A1
(43) Pub. Date: Jul. 14, 2005

(54) Electronic data security system and method

(75) Inventors: Phillip A. Viscomi, Boca Raton, FL (US); Steven R. Rodney, Plantation, FL (US); William E. Tessaro, Lake Worth, FL (US)

Correspondence Address: GREENBERG-TRAURIG, 1750 TYSONS BOULEVARD, 12TH FLOOR, MCLEAN, VA, 22102, US

(73) Assignee: Interfuse Technology, Inc., Boca Raton, FL (US)

(21) Appl. No.: 11/002,979

(22) Filed: Dec. 3, 2004

Related U.S. Application Data
(63) Continuation-in-part of application No. 10/883,187, filed on Jul. 2, 2004.
Application No. 10/883,187 is a division of application No. 09/855,425, filed on May 15, 2001, now Pat. No. 6,874,139.
(60) Provisional application No. 60/204,261, filed on May 15, 2000.
(60) Provisional application No. 60/618,604, filed on Oct. 15, 2004.

(51) Int. Cl. H04L 9/00

(52) U.S. Cl. 713/165

(57) ABSTRACT

A security system capable of providing seamless access to, and encryption of, electronic data. The security system integrates into an operating environment and intercepts calls between the operating environment and one or more Productivity Applications within the operating environment, thereby ensuring security policies are properly applied to all sensitive data wherever the data travels or resides.

This application includes material which is subject to copyright protection. The copyright owner has no objection to the facsimile reproduction by anyone of the patent disclosure, as it appears in the Patent and Trademark Office files or records, but otherwise reserves all copyright rights.

This application is related to, claims priority from, and is a continuation-in-part of, U.S. patent application Ser. No. 10/833,187, filed Jul. 2, 2004, which is a divisional of U.S. patent application Ser. No. 09/855,425, filed May 15, 2001, which claims benefit of U.S. Provisional Application No. 60/204,261, filed May 15, 2000; and is related to and claims priority from Provisional U.S. patent application Ser. No. 60/618,604. The teachings of these related applications are incorporated herein by reference in their entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of electronic file security, and more specifically provides a set of processes and functional components which are designed to execute in an operating environment to provide protection against unauthorized and undetected rendering and transformation of secured data in accordance with a business policy or set of policies.

### BACKGROUND OF THE INVENTION

As more and more computers are interconnected via public and private networks, companies and governmental agencies are becoming increasingly concerned about information security, much of it in the form of application data files. However, companies and governmental agencies have been slow to adopt current industry standard information security solutions, like Pretty Good Privacy.

One reason companies and governmental agencies have been slow to adopt the current industry standard solutions is the level of user interaction associated with using programs. For example, most current industry standard security solutions require users to indicate whether a specific file is to be encrypted or otherwise secured, to provide a special encryption password, and to otherwise interact with the security solution before the file is saved.

Some industry standard security solutions require users to store their application data files in a specific location on a local or network drive if the files are to be encrypted. Although encrypting files stored in a particular location provides security for the files stored in that location, any other files used by the computer are not encrypted. This means the user must be conscious of where and how a file is saved, and this additional layer of complexity makes it more likely that users will not comply with the requirements, which defeats the purpose of implementing the security solution.

Even where the users save files to the correct location or properly mark the files for encryption, most modern operating systems allow programs running in those operating systems to create temporary files as part of their operation. The operating system itself may also create a temporary page file, or spool file, to help with memory management issues. These temporary files frequently contain unencrypted copies of the primary data. Although these temporary files should be deleted by the programs which create them, they frequently linger on a computer's hard drive until deleted by the user. But even where the programs do delete the temporary files, typical deletion does not truly erase the file from the drive. Instead, only the reference to the file is removed from the file allocation table or other file management block; the actual data is left on the drive until overwritten. Between the undeleted temporary files and the file pieces remaining on the drive, hackers and other malicious users can easily gain access to data that the user thought was secure.

Because there is no way to control application-specific factors such as where temporary files are placed on the drive current industry standard security solutions cannot reliably protect sensitive data, especially data that is contained in temporary files. The end result is that users develop a false sense of security, which tends to lead to bad security practices.

Some operating systems and operating system add-ons allow users to limit access to individual files based on logon credentials. Although such a solution is advantageous because it can provide user and group level data access control, these systems do not encrypt the data, but rather simply insert flags in the file allocation table or other file management block that indicates which users and/or groups are to be given access to the data. This means that users who bypass the operating system imposing the controls, such as through the use of an alternative operating system, can still access the underlying information. By way of example, with NT File System (“NTFS”) enabled on a drive, the Windows 2000 Server operating system provides user and group level access control down to the individual file level. However, if a bootable floppy disc or CD-ROM is used to start the computer in DOS, programs such as NTFSDOS can allow any user to read and write to the data on the drive, despite the access control settings. As with the other security systems described above, users of such operating systems may develop a false sense of security.

Computer data security problems extend beyond simple, single computer environments. In enterprise environments, it is common for groups of users to share the same public network drives and folders via network permissions. Traditional, location-based encryption solutions only provide the same level of access permission to all users on the machine. This means that employees who store their files in a communal network storage location therefore may not have data security protection from each other.

Still further, current approaches to file access control and file protection are often dependent upon having continual access to a centralized server or set of servers that provides user authentication and authorization for operations on protected information. Unfortunately, due to the increasingly mobile nature of work, continuous connectivity cannot be guaranteed, thus users of such a system cannot access or use the protected information whenever needed.

Another problem facing today's businesses is the ease and frequency with which files can be transferred to others via indirect means, such as, but not limited to, through floppy discs, CD-RW's, portable solid state storage devices, and even E-mail. Sending a file via any of these means is completely insecure. By way of example, files attached to E-mail messages are easily intercepted while in transit between the sender and recipient. Location-based encryption software can do nothing to protect a file once it leaves its protected location and begins to travel via these indirect transfers.

### SUMMARY OF THE INVENTION

Accordingly, the present invention is directed to an electronic file security system and method that substantially obviates one or more of the problems due to limitations and disadvantages of the related art.

An object of the present invention is to provide for seamless, easy to use electronic file encryption which requires little or no technical expertise. Even employees who know little more than how to turn on a computer can utilize the system and methods described herein such that whatever data is created, regardless of where it is created or stored, is preferably automatically protected with encryption. In a preferred embodiment, no incorrect action can prevent an employee's files from being automatically protected.

It is another object of the present invention to seamlessly integrate with the operating system or operating environment, such that regardless of where an employee keeps his or her files, the files are protected. The employee does not need to remember to individually protect each new file storage location, or to save files into previously protected locations.

Still another object of the present invention is to monitor temporary files created by the operating system and/or individual applications, and to more completely delete such temporary files by wiping the associated binary data from the hard disk at the sector level so that the data cannot be recovered. In a preferred embodiment, such deletion should be done using techniques that meet or exceed the U.S. Department of Defense mandated standards for secure file removal necessary to prevent unauthorized disclosure of classified information.

Yet another object of the present invention is to allow users to share computers and network resources without risk. An embodiment of the present invention automatically encrypts files wherever they are located, and by default encrypts the files for use by a single user or authorized group of users. Other users sharing the PC or network file space preferably cannot open the files, regardless of whether thy have been granted network access permission or are able to gain physical access to a PC, unless the users have been authorized to open them.

An additional object of the present invention is to permit users to access and operate on protected information without requiring a real-time and continuous connection to a centralized server or set of servers.

Another object of the invention is to permit groups of users to exchange secured files, including via E-mail. Once a user joins a group, the user can choose which files are to be shared with the group. The present invention automatically encrypts and decrypts group files for members of the group, while keeping the files otherwise secured.

Still another object of the present invention is to provide electronic file encryption which is platform independent. This can allow users working in Microsoft Windows®, Linux®, UNIX, Microsoft PocketPC®, Java-based operating environments, Macintosh OS X, and other operating systems to take advantage of the encryption methods offered by the invention.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

The present invention is a set of processes and functional components executing in an operating environment, such as, but not limited to, an operating system, a runtime environment, or the like. The present invention provides protection against unauthorized rendering and/or transforming of secured data during the individual life-cycles of such files.

In a preferred embodiment, the present invention becomes operable as soon as an individual computing device, such as, but not limited to, a cellular telephone, pager, portable digital assistant, personal computer, or mainframe computer is turned on. Any files secured by the present invention which are present on the device can thus be automatically accessed once a user has authenticated himself or herself to the device. This is preferably achieved by integrating the present invention with the operating environment. One means for such integration is described in U.S. patent application Ser. No. 09/942,943, which is incorporated herein by reference in its entirety. However, one skilled in the art will appreciate that alternative integration techniques may be substituted therefor without departing from the spirit or the scope of the invention. Still further, although the present invention is described as an enhancement to traditional operating systems, it should be apparent to one skilled in the art that the techniques described herein can be used to integrate electronic file encryption into the core of an operating environment, or into one or more applications running in the operating environment.

A preferred embodiment of the present invention allows users to utilize traditional software applications in their customary and defined manner to create, render, and transform information into or from various electronic formats. This is preferably achieved without altering the traditional applications. By integrating with the runtime operating environment, rather than a specific application, the present invention can provide enhanced data security without impacting standard computer functions, such as, without limitation, anti-virus scans of the software applications. Furthermore, such protection can be provided in compliance with a central security policy that is established by an organization at a variety of levels, including, but not limited to, general organization, user group, individual user, and/or Productivity Application levels.

In addition to providing electronic file security, a preferred embodiment of the present invention can ensure that the integrity and security of supporting functions is maintained. Integrity and security assurance methods preferably include, but are not limited to, improved user authentication for the purpose of creating secured files and identification and disposition of various threats that may compromise process integrity.

A preferred embodiment of the present invention is client device centric. This allows the present invention to maintain security and integrity independent of central server and network security. This means that a user in a remote location who is disconnected from a communications network will still comply with an established business security policy.

As previously described, the overall architecture of the present invention is preferably not tied to any single operating environment, particular hardware, or specific encryption technology. This is preferably achieved by employing the security and other aspects of the invention within a secure application data file or the equivalent thereof. By employing security within an application data file, data stream or the like, users can freely exchange secured files without the costly and undesirable requirement of upgrading to a specific operating system, updating all operating systems to a specific configuration, or even adopting standardized encryption methods. Further, a business can securely exchange information with another business or external clients or consultants without regard for the type of equipment at the receiving location.

By way of example, without intending to limit the present invention, Company A may run a Microsoft Windows® XP based network, and use Microsoft Office™ as their standard Productivity Application suite. Company A may maintain a variety data types, each with their own security needs. For example, human resources information may be encrypted using 2048-bit encryption because of the sensitivity of the information contained in such records. By contrast, a file containing project status information may be encrypted using 64-bit encryption due to the fact that the information is frequently accessed and modified, and because the information contained therein is not as sensitive. By allowing Company A to utilize different encryption techniques and different levels of encryption, the present invention is more responsive to Company A's needs than traditional encryption systems.

Still further, the present invention preferably allows Company A to add or exclude some or all software applications from a list of Productivity Applications. In one embodiment, the system limits application of electronic file security to only data and/or files associated with specified Productivity Applications. This allows the system to avoid encrypting all files on a drive, which can be computationally and resource intensive, especially for files which need not be secured, such as personal MP3 files, photographs, or the like. Although the disclosure focuses on individual data files, it should be apparent to one skilled in the art that the invention can be adapted to work with streamed and other forms of data as well.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a block diagram illustrating an initialization procedure implemented in a preferred embodiment of the present invention.

FIG. 2 is a block diagram illustrating steady state functionality of a preferred embodiment of the present invention.

FIG. 3 is a block diagram illustrating preferred workgroup management functionality.

FIG. 4 is a block diagram illustrating a preferred policy enforcement process.

FIG. 5 is a functional diagram illustrating components of various aspects of the system.

FIG. 6 is a block diagram illustrating a preferred secure workgroup creation process.

### DETAILED DESCRIPTION OF THE PREFERRED EMBODIMENT

Reference will now be made in detail to the preferred embodiments of the present invention, examples of which are illustrated in the accompanying drawings.

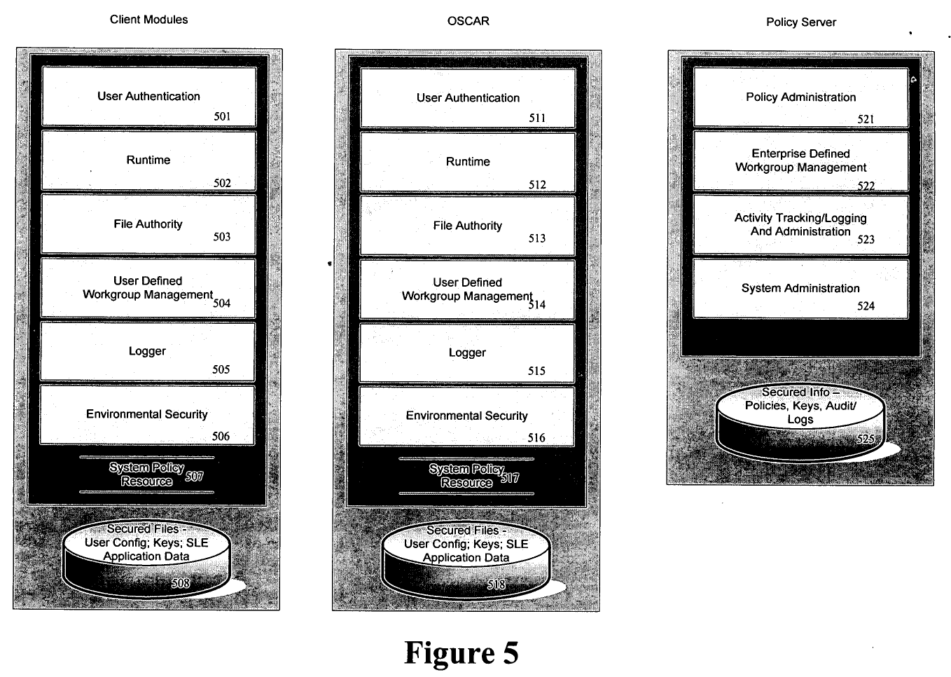

As illustrated in FIG. 5, the present invention is preferably architected primarily around six logical components, User Authentication 501, 511; Runtime Component 502, 512; File Authority 503, 513; Workgroup Management 504, 514; Logger 505, 515 and Policy Administration 521. These components perform the processing necessary to secure, control access to, and control transformation of information in data files and messages manipulated by Productivity Applications used by an organization. Below is a description of the functions and processing associated with each component.

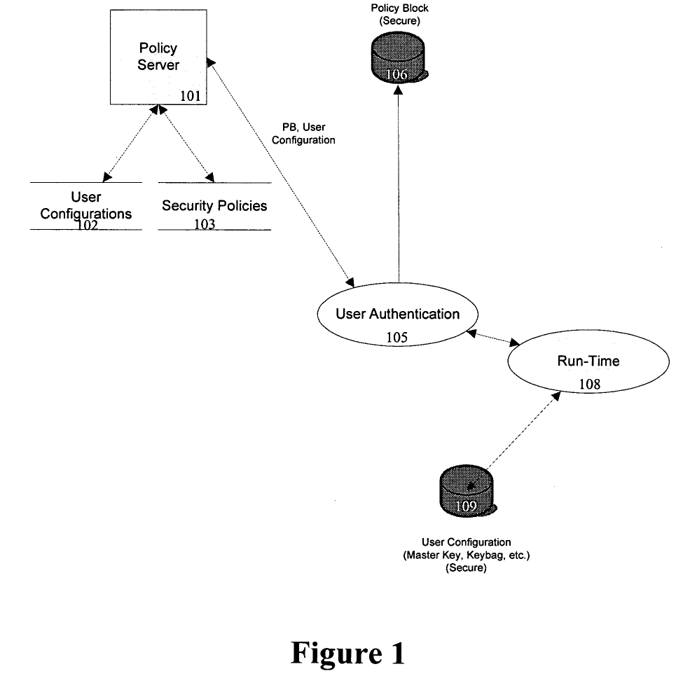

The User Authentication (“UA”) component (Blocks 501 and 511 of FIG. 5) controls identification of, and access by, an individual user to the system, and handles the user-specific security operating parameters and reporting data contained therein. A preferred user authentication and system initialization process is illustrated in FIG. 1.

When initialized, User Authentication 105 preferably establishes a user's identity to determine access to the system. This function may utilize credentials provided by single or multifactor authentication devices, such as, but not limited to, biometric devices, security tokens, Public Key Infrastructure (“PKI”) systems, and the like. Single factor authentication may, for example, be initiated when the user, prompted by User Authentication 105, enters a password or presents an alternative authentication means. A previously stored randomized value (“salt value”) is retrieved from the operating environment's current user context, a cryptographic hashing algorithm is applied to this password and salt value, and the resulting digest is compared to the digest associated with the operating environment's current user context. If the values compare correctly, the user is deemed to be authenticated.

Multi-factor authentication can be initiated when a user presents, or is prompted to present, a physical token to a reading device attached to the PC, and then enters a Personal Identification Number (“PIN”). If the correct PIN is entered, the password is retrieved from a user-specific sub-division of the token. A previously stored salt value and cryptographic hashing algorithm are applied to the password, and the resulting digest is compared to the value associated with the operating environment's current user context. If the values are equivalent, the user is deemed to be authenticated

Upon successful authentication, Policy Server 101 is contacted and Policy Block 106 and User Configuration 109 are retrieved, processed, and cached on the user device for local use. Policy Block 106, also referred to as the PB, is preferably comprised of Enterprise, Group, and User Policy Sub-Blocks (respectively “EPB”, “GPB”, “UPB”) and is cryptographically signed to detect in-transit or local alteration. Policy settings present in the various Policy Blocks 106 are preferably hierarchical in precedence and application, with the hierarchy from lowest precedence to highest as follows: i) Enterprise Policies; ii) Group Policies; and iii) User Policies. Although such an hierarchical precedence is presently preferred, it should be apparent to one skilled in the art that alternative arrangements, including but not limited to, precedence arrangements applied to individual policy settings, can be substituted therefor without departing from the spirit or the scope of the invention.

In a preferred embodiment, if Policy Server 101 is unavailable, such as, but not limited to, if the user device is not connected to a network, a previously cached version of Policy Block 106 is used. User Configuration 109 preferably includes the user's master symmetric key, private keys, and group symmetric keys. A User Configuration 109 retrieved from Policy Server 101 is preferably processed to synchronize it with the locally cached User Configuration to determine if any changes, including, but not limited to, removal from a secured workgroup (described below) by an administrative action, have occurred since the last time the Policy Server was contacted. After User Configuration 109 is synchronized, any changes to the user-specific information, including, but not limited to, changes to the user's master key, public keys, and/or symmetric keys, are preferably placed in this local cache for on-going usage and in preparation for the next synchronization with Policy Server 101.

In a preferred embodiment, the circumstances surrounding the user's current attempts to utilize the system (i.e. the user's “context”) are then evaluated according to the policy elements in the PB. If it is determined that the user is “at risk”, the user is prevented from accessing security resources and secured application data. By way of example, without intending to limit the present invention, Enterprise Policies may specify that, by default, any users who are not able to access the Policy Server, or who have not accessed the Policy Server within a specified period of time, cannot access secured files. Such a scenario would prevent, for example, a user who has stolen a laptop and managed to log in as a system user from accessing secured information on the laptop.

If the user is deemed to not be “at risk”, the system then preferably establishes access to the user's set of system resources, including the user's master key. This master key is then used to decrypt the user's personal encryption/decryption key sets and to determine the user's membership in a set of secure workgroups. There are preferably at least two components of secure workgroup management, Enterprise Defined Workgroups (“EDW's”) and User Defined Workgroups (“UDW's”). EDW's are groups established by an organization to facilitate and streamline access controls within the organization. UDW's are ad-hoc groups which are created by an authorized user inviting a recipient to join the UDW. Joining a secure workgroup inserts a symmetric key for the group into the local User Configuration's “key bag.” A key bag is a repository for the user's private key, public keys and symmetric keys for groups of which the user is a member.

The system installation type is then determined. Preferred system installation types include, but are not limited to, a fully licensed installation for the particular user device and an Operating System Secure Collaborator and Reader utility (also referred to as OSCAR). An architectural comparison of fully licensed installation 500 and OSCAR 510 is illustrated in FIG. 5.

In a preferred embodiment, the system is capable of maintaining a secure log of all file access and file operations. Whether such a log file is maintained, and the context, granularity, and other attributes of the log file entries, can be controlled via corresponding PB elements, including any file policy elements (“SIB-LOPS”) as part of a Current File Policy (“CFP”). If logging is requested as part of the CFP, such logging is also preferably begun as part of secure file creation/open process.

The Runtime (RT) component, illustrated in FIG. 5 as Blocks 502 and 512, provides many of the core content and meta-data retrieval, transformation, storage processing, and other functions needed to secure and store application file data, E-mails, and the like, according to business security policies. The Runtime component interoperates with other operating environment components, system components and resources, and the Productivity Applications, to protect data created, edited, and rendered in the Productivity Applications.

In a preferred embodiment, the Runtime component preferably reads, edits, and writes Clear Information Blocks (“CIB's”). CIB's preferably contain non-encrypted meta-data applicable to each file. Such non-encrypted meta-data preferably includes, but is not limited to, information identifying the secure workgroup which is permitted access to the data file's contents, and one or more tamper indicator elements. Such tamper indicator elements may be used to determine if Secure Information Block (“SIB”) alteration has occurred. CIB's also preferably include application-specific meta-data created and altered by the application (e.g. author, creation date, custom keywords, and the like). On systems without the present invention installed, such meta-data may have been part of a file's information; the present invention preferably separates out such meta-data such that the meta-data remains accessible to outside applications (e.g. search, backup, etc.).

The Runtime component can also preferably read, decrypt/encrypt, and write SIB's. SIB's preferably contain meta-data applicable to each file. Meta-data stored in a SIB preferably includes, but is not limited to, Rights Management (“RM”) settings, embodied in “SIB-ROPS” attributes which govern the various permissible and denied operations recipients may perform on the file; log settings for recording success/failure of user-initiated operations (“SIB-LOPS”); log settings determining the logging server and mechanism used to report log events (SIB-LRPT); and tamper indicator elements which may be used to identify if a Secure Content Block (“SCB”) has been altered.

A preferred embodiment of the Runtime component can also preferably read, edit, and write Clear Content Blocks (“CCB”). Data stored in a CCB preferably includes elements that indicate to systems without the present invention installed that the file is protected by the present invention and that the accessing user is unable to or not permitted to access the secured content.

The Runtime component can also preferably read, decrypt/encrypt, and write SCB's. An SCB is preferably opaque to other utilities running in the operating environment, such as, but not limited to, anti-virus programs, spyware detection software, and the like. In a preferred embodiment, an SBC preferably includes, but is not limited to, the portions of the application data file which are visible to an authorized user. Such portions may include, but are not limited to, the text and/or embedded objects for a word processing file, the worksheets' contents for a spreadsheet, and the like. Such portions are preferably encrypted for a specific secure workgroup.

A preferred embodiment of the Runtime component can also intercept a Productivity Application's invocations of certain operating environment functions, services, inter-process communication, and inter-process data transfer operations. The Runtime component can then allow, prevent, or redirect these operations according to a variety of factors, including, without limitation, the Current File Policy (“CFP”), certain user actions, and transformations performed on secured data and information. Such transformations can include, but are limited to:
a. File-related macro operations (e.g., open, close, save, rename);
b. User-application related functions (e.g., copy to clipboard, paste from clipboard, export/import via operating system-specific mechanism);
c. Printing;
d. Rights management setting or changing; and,
e. Encryption group changing.

The Runtime component is also preferably responsible for initializing, controlling and interfacing with external cryptographic modules via their defined APIs. This allows the Runtime component to encrypt, decrypt, and validate SIBs, SCBs, and associated tamper indicator elements. The system's architecture preferably supports a plurality of encryption algorithms, including, but not limited to, the AES, 3DES, and Blowfish encryption algorithms, through an abstracted interface.

Still further, the Runtime component can preferably track the creation and use of all application temporary files. This allows the Runtime component to delete, preferably to the United States Department of Defense's National Industrial Security Program Operating Manual (“NISPOM”) standards, all such temporary files when closed. By performing such deletions, the Runtime component allows the system to prevent inadvertent compromise of protected information.

The Runtime component can also preferably generate Secure Log Events (“SLE”) for any events that, according to the Current File Policy, should be logged. These SLE's are preferably transferred to the UA component for queuing and transmission to individual Log Servers. Log Servers 213, identified by PB attributes and corresponding CFP information, provide SLE destination points, SLE decoding (using Policy Server escrowed secure workgroup symmetric keys), storage, and optional reporting to other industry-standard event notification systems and management systems.

The File Authority (“FA”) component, illustrated in FIG. 5 as Blocks 503 and 513 preferably, provides the interpretation and notification processes and functions needed to coordinate system component actions and processing to comply with the set of applicable EPB, GPB, UPB, CIB, and SIB. A comprehensive CFP is constructed and contains the Runtime combined set of actions and transformations the current user may take or perform on the current Productivity Application data file. A preferred embodiment of the CFP includes, but is not limited to:
a. The PB settings applicable to the current user and application (see GPB for application-specific information); and,
b. Retrieved CIB and SIB, or, if a new file, default constructed CIB and SIB (see below).

The FA component performs a variety of functions related to the interpretation of the above-mentioned policy blocks to determine what actions a user can take on a given file. By way of example, without limitation, the FA component can determine if the current user can access a given file based on the user's secure workgroup membership. The FA component can also preferably determine the type(s) of encryption applicable and an automation level for this user and file combination based on the PB (including UPS, described below) and, if present, the CIB and SIB. A preferred FA component can also interpret SIB-ROPS to determine allow/deny permissions for individual file macro operations, interpret SIB-ROPS to determine allow/deny permissions for application editing and rendering functions, interpret SIB-ROPS to determine if there are start and/or end time access limits, and interpret SIB-LEVT and SIB-LRPT to determine log event settings applicable to this user and current file. A preferred FA component also preferably constructs CIB and SIB elements, as well as CFP's, as needed.

The Workgroup Management (“WM”) component, illustrated in FIG. 5 as Blocks 504 and 514, provides the processes and functions needed to create, edit, and delete secure workgroups, and to associate users with those secure workgroups. Secure workgroups associate a group of one or more users with a specific symmetric encryption key, thus providing any user who is a member of the group with access to Productivity Application data files and/or E-mail messages encrypted for that group. A preferred WM component also preferably provides for centralized administration of Enterprise Defined Workgroups (“EDW”) through Lightweight Directory Access Protocol (“LDAP”) enabled directories. System-specific schema extensions may be made to the directories' structures to support the EPB, GPB, and UPBs. Although LDAP directories are currently preferred, it should be apparent to one skilled in the art that alternative directory technologies may be substituted therefor without departing from the spirit or the scope of the invention.

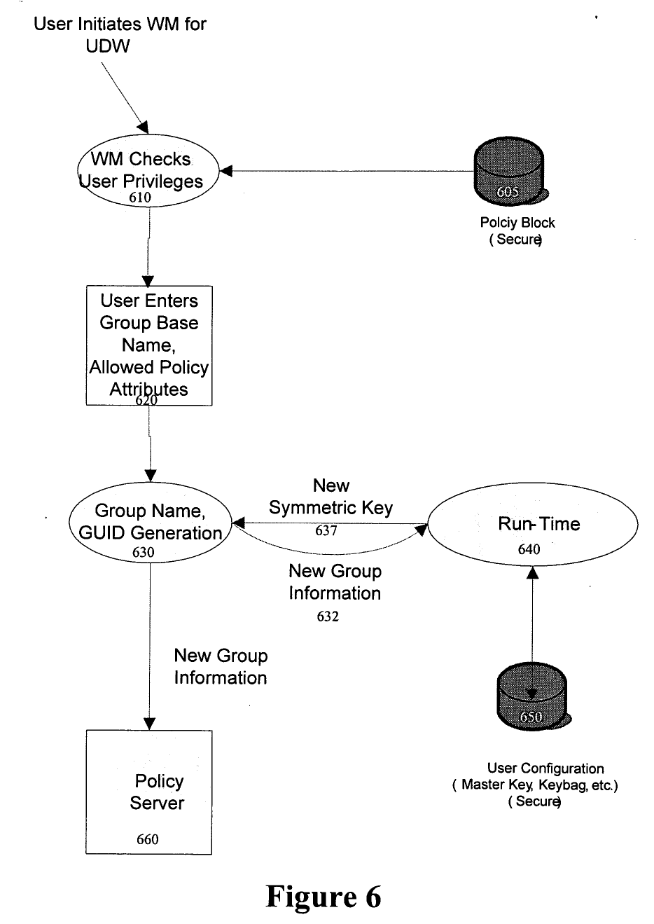

A preferred WM component embodiment, illustrated in FIG. 6, preferably allows users to create ad-hoc, self-administered confidential UDW's. Users gain access to UDW secured files and E-mail messages by accepting invitations to join a UDW or by creating a UDW. In a preferred embodiment, the GPB's User Privilege Sets (“UPS”) can include an attribute indicating the user's authority to create UDW's.

Generally, UDWs initially contain a single member, the UDW creator. As illustrated in Block 610, when a user creates a UDW, the creator preferably first supplies a name for the UDW and selects applicable Policy Attributes for the documents secured by this UDW (Block 620). These attributes, some corresponding to Policy Block 605 attributes (e.g. SIB-LRPT), include, but are not limited to, the ability of Group members to invite others to the group any time span requirements for group members to check with the creator's Policy Server for revocations (corresponding to EPB), the requirement that documents have their policy attributes kept consistent with UDW level attributes (i.e. no document overrides), and any logging requirements for document access corresponding to this group. In Block 630, the WM component 610 requests a globally unique ID from the operating environment, or, where the operating environment is not capable of providing such an ID, generates such an ID by internal means. The WM component then requests, from the RT component 640, a new symmetric key 637. This symmetric key is combined with the other UDW information and then the WM component 610 returns the composite group information to the RT component 640 for local storage, and sends the new group information 632 to the Policy Server 660 for escrowing.

Adding users to a UDW is preferably performed by an authorized user (the UDW creator or a user who has been granted “Invite Others” authority). In one embodiment, the authorized user preferably selects the UDW for invitation generation and enters a confidential password for securing the invitation. The WM component then creates an invitation file, which includes the UDW identifiers, Policy Attributes and the group symmetric key. The invitation file is then E-mailed or otherwise transferred to an invitee, and the confidential password is communicated over a secure separate channel (e.g., a telephone call; a separate, encrypted E-mail; or the like). The invitee can open the invitation E-mail, follow an automated procedure that is defined in the invitation E-mail, and enter the confidential password. This password and a salt value are then preferably cryptographically hashed and compared to the invitation file's protection digest. If authenticated, the rest of the invitation file is decrypted, the UDW identifiers and group symmetric key are stored in the local User Configuration keybag, and a User Configuration escrow is scheduled for later synchronization with the Policy Server. Once this process is complete, secure files and E-mail messages may be exchanged with UDW group members without using any passwords. In a preferred embodiment, UDW invitees may use either the OSCAR utility or a fully licensed copy of the system software to exchange secure files and messages.

Within a Policy Server, the Policy Administration (“PA”) component, illustrated in FIG. 5 by Block 521, provides the processes and functions necessary to create, edit, and delete various enterprise, group, and user specific attributes associated with each user and user group. These attributes can be used to implement a business information security policy, and are preferably stored on a centralized Policy Server to provide consistent application across an enterprises' entire infrastructure. The business information security policy is preferably administered by a security administrator separate from standard system or network administrative roles.

PA 521 preferably permits the creation, management, and assignment of enterprise, group, and user-specific policy attributes (corresponding, respectively to the EPB, GPB, and UPB's described above). In a preferred embodiment, an EPB preferably includes a plurality of attributes. Such attributes include, but are not limited to, a Remote Secure attribute, which indicates the number of days a user device with system installed is allowed to not connect to the Policy Server. When the parameter is exceeded and a system-configured user logs in to the user device, the corresponding keybag is destroyed to eliminate the possibility of accessing system-secured data. The security administrator can re-enable user access by transferring escrowed user-specific information from the Policy Server to the user.

In a preferred embodiment, a GPB preferably includes a plurality of attributes. Such attributes include, but are not limited to, groupings of privileges, or User Privilege Sets (“UPS”), associated with an appropriate UPS. Each UPS, (an exemplary embodiment of which is described in Appendix A), preferably includes an indicator of the encryption automation level, which may be varied for each Productivity Application; an indicator of the authority to create and manage UDWs; and an indicator of the authority to assign Rights Management attributes to a secured file.

In a preferred embodiment, a UPB preferably includes a plurality of attributes. Such attributes include, but are not limited to, a user enabled state attribute, which allows a security administrator to disable a specific user's access to secured files and E-mail messages; and a User Home Group attribute which, if set, prohibits the user from limiting access to files and E-mail messages to themselves only.

To provide the features and functions described above, the system operates in different interaction and processing configurations at different times. Each time the user device starts and lets a user login, the system will preferably cycle through at least some of these configurations. Depending on user-initiated actions, the system may activate different components and/or processing steps, and may interact with various operating environment, network, and external resources.

In a preferred embodiment, the system modifies the operating environment such that the operating environment is required to initialize system features prior to any Productivity Application being loaded. This allows the system to establish, for a given user, the appropriate access to operating environment resources, system resources, and user-specific information. FIG. 1 is a block diagram illustrating a preferred initialization sequence. Initialization preferably begins when the user executes an operating environment login sequence and begins the operating environment login process. After the operating environment user context is valid, but before the user can interact with the system, and preferably before the user can interact with additional features of the operating environment, the system checks all file security components and resources for consistency and tampering. Failure of any validation will preferably cause the system to fail safe. That is, the system will not allow the user to access secured files or E-mail messages.

In a preferred embodiment, the next step is for Runtime 108 to establish access to system resources and insure that it can interface with the defined Productivity Application(s). This is preferably achieved by using operating environment system calls to associate Runtime 108 with the operating environment's application loading sub-system. Such association causes Runtime 108 to be notified when any application is being loaded by the operating environments. This allows Runtime 108 to determine, for each application loaded, if the loaded application is a Productivity Application. If the application being loaded is a Productivity Application, Runtime 108 uses operating environment system calls to associate Runtime 108 with the Productivity Application, thereby allowing Runtime 108 to be notified as the Productivity Application makes calls to the operating environment (see below).

With Runtime 108 properly instantiated within the operating environment, the UA 105 is preferably activated to authenticate the user to the system. This results in the establishment of a user-specific system context, which is synchronized with the Policy Server and establishes access to the system functions and resources. The system then enters a steady state until Runtime component 108 is notified by the operating environment that an application is being loaded for execution.

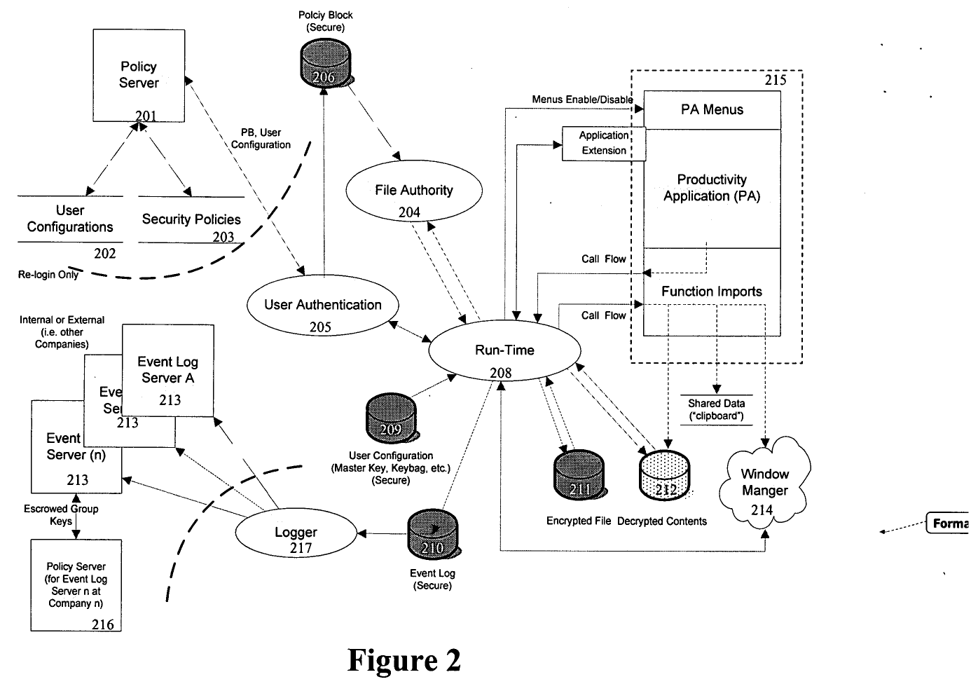

In normal, or steady state operation mode, illustrated in FIG. 2, each time the operating environment loads an application, Runtime 208 is notified and determines if the application is a Productivity Application. If the application is not a Productivity Application, Runtime 208 performs no further processing and system interaction ceases. If the application is a Productivity Application, then Runtime 208 uses operating environment system calls to associate Runtime 208 with Productivity Application 215, thereby allowing Runtime 208 to be notified as Productivity Application 215 makes calls to the operating environment. Such calls may include, but are not limited to, opening a data file for read access by Productivity Application 215, opening a data file for write access by Productivity Application 215, closing a data file currently in use by Productivity Application 215, and the like. Using operating environment system calls, Runtime 108 also preferably causes its own user interface window processing functions to be inserted into the application's loading and user interface window handling sequences and receives notification prior to the application receiving control. Runtime 208 then inserts its own handling functions into the Application Programmer Interface (API) call flow and establishes the required system hooks by retrieving Productivity Application 215's function import table entries, inserting its own entry points in their places, and storing the original entries for later use. Such later use typically involves allowing the originally designated calls to execute after Runtime Component 208 performs pre-processing, and then post-processing before letting control return to Productivity Application 215. Runtime component 208 preferably inserts a visual indicator in Productivity Application 215's user interface which acts as an interaction anchor in Productivity Application 215's main window and provides the user access to system features and processing.

If Productivity Application 215 attempts to open a file which has already been secured by the system, Runtime 208 can intercept the action and open the file for further investigation. Once open, Runtime 208 can determine if the open file is a secured file by determining whether a CIB and/or SIB is present in the file. If the open file is not a secured file, Runtime 208 passes the file contents to the Productivity Application and continues to monitor the user interface anchor for user requests to secure the file. If the open file is a secured file, Runtime 208 passes the retrieved CIB and SIB to the FA, which returns a CFP upon which Runtime component 208 can act.

If Productivity Application 215 attempts to create a secured file, Runtime 208 preferably retrieves a CFP from the FA, which is generated in accordance with the PB for the new file. Based on the CFP, Runtime 208 preferably enables and/or disables toolbar items and menu choices available within Productivity Application 215 such that the user is visually aware that these menu choices and/or toolbar items are not allowed for the given file or file type. Runtime 208 also preferably enables and disables Productivity Application 215 short-cut keys, enables/disables various Productivity Application 215 functions, monitors the invention's user interface anchor menu (placed as part of the Productivity Application menu bar), and generates, based on the CFP, Secure Log Events (“SLE”).

When Productivity Application 215 attempts to close a secured file, if the current CFP indicates mandatory protection, the file is encrypted using the CFP's current secured workgroup or, if the current CFP indicates the user has appropriate privileges, using either a user-selected EDW/UDW or the current user's Home Group. All temporary files created by the Productivity Application that are not currently in use are then permanently deleted.

In addition, steady-state system processing preferably includes allowing Logger component 217 to determine if queued Secure Log Events (“SLE”) exist and should be transmitted to Log Servers 213. If such events should be transmitted, Logger component 217 preferably attempts to contact the corresponding Log Server(s) 217 and process the events, and continues to do so in the background during the entire user login as needed.

If a login timeout period expires, any Secured Files currently in a Productivity Application are preferably secured, then the user is preferably logged out of the system. Although the system has been logged out of the system, in one embodiment the user can still utilize other aspects of the operating environment; the user is simply prevented from accessing system protected data. If a user is logged out and attempts a system-supported action, the user will be prompted for his or her login credentials and the initialization (see FIG. 1) will begin with system authentication.

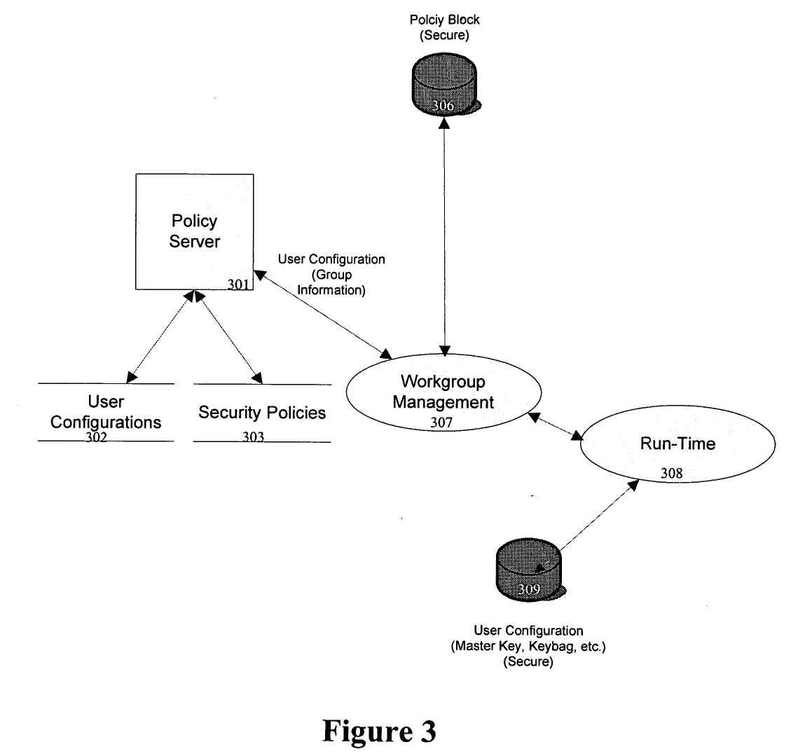

FIG. 3 is a block diagram illustrating workgroup management features of the system. In normal operation, the user can, if the PB permits, create, invite, and delete access to UDW. The user can preferably invoke Workgroup Management 307 to generate and administer secure Workgroups.

Workgroup Management 307, operating in a authenticated environment, preferably has full access, via the Runtime component 308, to the encrypted user configuration including the “keybag” file (Block 309) which represents the mapping of the workgroup names to symmetric keys used for protecting the SIB and SCB of the Productivity Application data files and E-mail messages. A preferred Workgroup Management 307 allows a user to invoke the Create Group functionality by permitting the user to enter a new group base name. This new base group name is preferably combined with a generated globally unique ID (“GUID”) and an enterprise-wide, pre-defined Company Name, thus ensuring name space uniqueness across companies. Once the new group name has been specified and GUID generated, Workgroup Management 307 requests a new symmetric key from the Runtime component 308 for the active encryption algorithm. The resulting key is combined with other information, including, without limitation, the GUID, the Company Name, and the base group name, to form an information packet. This information packet is preferably saved locally and protected using standard communication/encryption techniques, such as, without limitation, the Diffie-Hellman encryption technique and sent, if communications are possible, to the Policy Server 301 for escrow. If communications are not possible, the protected packet is queued for transmittal to the Policy Server 301 at its next contact.

Once the protected packet has been transmitted or queued for transmission to the Policy Server a success indication is returned to Workgroup Management 307. Workgroup Management 307 preferably stores the new Workgroup information in encrypted keybag/local configuration 309. Once the workgroup has been created and registered with the encrypted keybag, a properly authorized user can use Workgroup Management 307 to create password-protected Group Invitations, as defined above, and begin sharing files with other users.

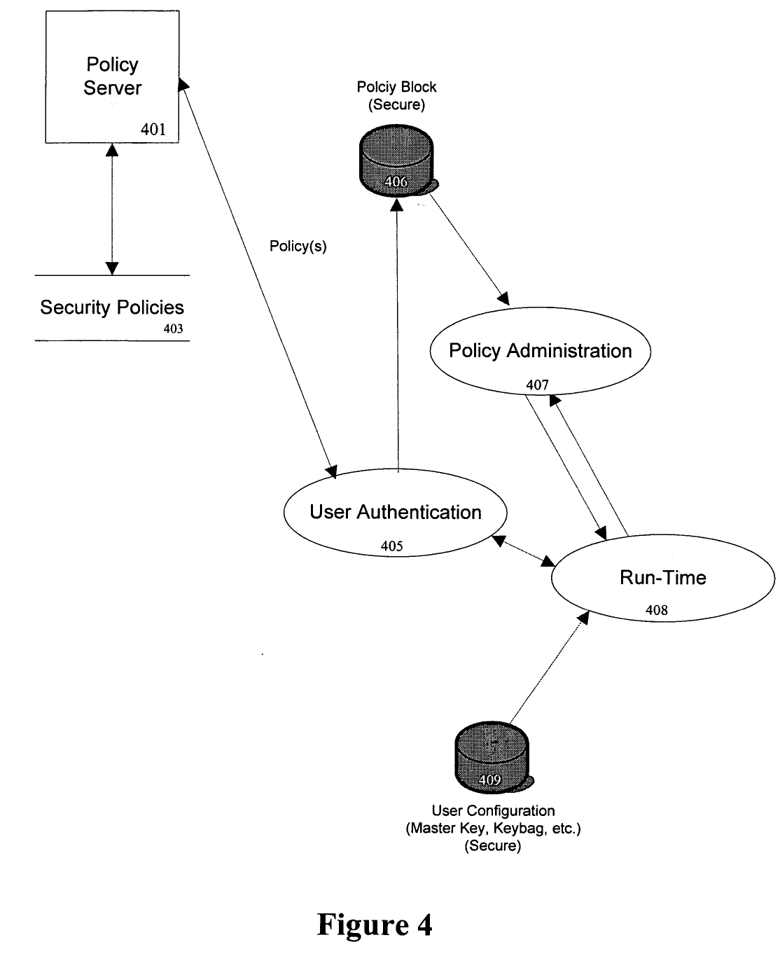

Policy Server 501 of FIG. 5 preferably uses Policy Administration 521 to set Enterprise, Group, and User security policy attributes. Policy Administration 521's relationship to other system components is depicted in FIG. 4.

Policy Administration 407 can only be invoked by a designated Administrator. Software-based wizards are used to embody the business policies relevant to various organizational and operational levels. See Appendix A, which is incorporated herein by reference in its entirety, for a listing of preferred Policy Block data elements and attributes. Appendix B, which is incorporated herein by reference in its entirety, includes a listing of preferred secured file data elements and attributes. In cases where policy attributes can be applied at multiple levels, the system preferably uses the following precedence to determine the end, effective policy to be applied:
1. User Policies, if defined, override all others
2. Group Policies, if defined, override Enterprise policies
3. Enterprise Polices form the basic attribute set for all users in a Company.

An administrator, invoking Policy Administration 521, can construct and set the various attributes in the desired policies. Each policy consists of from 1 to (n) attribute pairs and supporting information with, each attribute pair preferably consisting of an AttributeName and an AttributeValue. Each AttributeValue's allowable range is dependent upon the Policy scope and Attribute it corresponds to (see Appendix A). Upon saving, the new set of policies and attributes are preferably sent to the Policy Server for storage and later retrieval by system clients

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents. By way of example, without limitation, although a preferred embodiment of the system is defined as being comprised of six components, it should be apparent to one skilled in the art that the number of components, and the functions performed by a given component, can be altered without departing from the spirit or the scope of the invention.

1. An electronic data security system comprising:
an operating environment;
at least one Productivity Application capable of operating within the operating environment;
a Policy Administrator component, wherein the Policy Administrator component allows a data security system administrator to create, edit, and delete at least one security policy attribute which is associated with the system;
a Workgroup Management component, wherein the Workgroup Management component allows an operating environment user to create, edit, and delete at least one secure workgroup, including creating, editing, and deleting at least one attribute associated with each at least one secure workgroup;
a User Authentication component, wherein the User Authentication component controls identification of, and access by, the operating environment user to system resources and functions, including identifying at least one secure workgroup to which the operating environment user belongs;
a File Authority component, wherein the File Authority component interprets at least one security policy attribute and at least one attribute associated with at least one secure workgroup to which the operating environment user belongs to determine what actions the operating environment user can take on particular data associated with the Productivity Application; and,
a Runtime component, wherein the Runtime component coordinates communications between the other system components, the operating environment, and the at least one Productivity Application to protect the particular data associated with the Productivity Application.

2. The electronic data security system of claim 1, wherein the Policy Administrator component allows a system administrator to create, edit, and delete security policy attributes at at least one of a plurality of levels;

3. The electronic data security system of claim 2, wherein the Policy Administrator component allows a system administrator to create, edit, and delete security policy attributes at the enterprise, user group, and user levels.

4. The electronic data security system of claim 3, wherein the User Authentication component applies the security policy attributes in a hierarchical fashion.

5. The electronic data security system of claim 4, wherein the User Authentication component applies the security policy attributes by default such that the user level security policy attributes take precedence over the user group level and enterprise level security policy attributes, and the user group level security policy attributes take precedence over the enterprise level security policy attributes;

6. The electronic data security system of claim 5, wherein a data security system administrator can alter individual policy attribute precedences through at least one security policy attribute setting.

7. The electronic data security system of claim 1, wherein the user authentication component controls identification of an individual operating environment user and controls access to electronic data within the system by the individual operating environment user based on the security policy attributes.

8. The electronic data security system of claim 1, wherein the Policy Administrator allows defining of user groups and the Workgroup Management component allows the operating environment user to be a member of at least one user group.

9. The electronic data security system of claim 1, wherein the runtime component is configured to intercept calls made by the Productivity Application to the operating environment.

10. The electronic data security system of claim 9, wherein the runtime component allows, prevents, transforms, or redirects the intercepted calls based on a current file policy associated with the particular data.

11. The electronic data security system of claim 9, wherein the runtime component is configured to intercept calls made by the Productivity Application to other applications running within the operating environment.

12. The electronic data security system of claim 11, wherein the runtime component allows, prevents, transforms, or redirects the intercepted calls based on a current file policy associated with the particular data.

13. The electronic data security system of claim 1, wherein the particular data includes at least one Clear Information Block, at least one Secure Information Block, at least one Clear Content Block, and at least one Secure Content Block.

14. The electronic data security system of claim 13, wherein the content of the at least one Secure Content Block is encrypted.

15. The electronic data security system of claim 13, wherein the at least one Secure Information Block includes rights management information and is associated with at least one tamper indication element.

16. The electronic data security system of claim 15, wherein the tamper indication element is indicative of unauthorized alterations to the Secure Information Block.

17. The electronic data security system of claim 15, wherein the tamper indication element is indicative of unauthorized alterations of the particular data as a whole.

18. The electronic data security system of claim 15, wherein the tamper indication element is indicative of unauthorized alterations of the Secure Content Block.

19. A method of protecting electronic data, comprising:
loading an operating environment to be used by a user;
loading a monitoring application within the operating environment, wherein the monitoring application performs the following as it loads:
authenticating the user;
if a Policy Server is available, retrieving Policy Block and User Configuration information from a Policy Server, processing the Policy Block and User Configuration information, and caching the Policy Block and User Configuration;
if a Policy Server is unavailable, processing the cached Policy Block and User configuration information;
evaluating the current user context to determine whether the user is at risk and preventing any access to protected electronic data if the user is at risk;
monitoring each application launched within the operating environment to determine whether the launched application is a Productivity Application;
if the launched application is not a Productivity Application, permitting the launched application to directly interact with the operating environment;
if the launched application is a Productivity Application, performing the following:
decrypting protected electronic data if the user is a member of the secure workgroup associated with the protected electronic data and making the decrypted data available to the Productivity Application;
loading data security policy attributes stored with the protected electronic data;
monitoring interactions between the Productivity Application and the operating environment and allowing, preventing, transforming, or redirecting the interactions based on system security policy attributes contained within the Policy Block and the data security policy attributes stored with the protected electronic data; and
permanently deleting any temporary files created by the Productivity Application when the temporary files are no longer in use.

20. The method of claim 19, wherein the permanent deletion of the temporary files is done to NISPOM standards.

21. The method of claim 19, wherein interactions between the Productivity Application and the operating environment which cause protected data to be written to a file results in encryption of the protected data according to the corresponding system security policy attributes and the data security policy attributes.

22. The method of claim 21, wherein the encryption includes a group-level key.

23. The method of claim 19, further comprising validating the decrypted protected electronic data and the data security policy attributes using a tamper indicator associated with the data.

24. The method of claim 19, further comprising logging any events that are to be logged according to a current file policy.

25. The method of claim 24, wherein the current file policy is generated from the contents of the Policy Block and the policy attributes which are part of the protected electronic data.

26. The method of claim 24, wherein the corresponding attributes of the current file policy are stored as part of the protected data.

27. The method of claim 19, wherein the protected data includes at least one Clear Information Block, at least one Secure Information Block, at least one Clear Content Block, and at least one Secure Content Block.

28. The method of claim 27, wherein the at least one Secure Information Block and the at least one Secure Content Block are the only encrypted portion of the protected data.

29. The method of claim 27, wherein the Secure Information Block and the Secure Content Block have at least one tamper indicator element associated with them.

30. A method of defining user access to protected electronic data, comprising:
permitting a system administrator to define a set of possible users;
permitting the system administrator to define a set of user groups;
permitting the system administrator to define a set of policy attributes applicable to at least one user group;
allowing a system user to create data which is to be protected;
allowing the system user to define a secure workgroup, such that members of secure workgroup are given access to the protected data;
creating at least one encryption key for the at least one secure workgroup;
encrypting the data which is to be protected using the encryption key for the secure workgroup;
inviting users, and members of user groups to join the secured workgroup; and
authenticating an invitee invitation and, if authenticated, providing the encryption key for the secure workgroup to the invitee.

31. The method of claim 30, wherein invitee authentication is based on single factor authentication.

32. The method of claim 31, wherein the single factor authentication is a biometric identifier.

33. The method of claim 31, wherein the single factor authentication is a shared passphrase provided to the invitee by the user.
